(19) United States
(12) Patent Application Publication
(10) Pub. No.: US 2025/0227747 A1
(43) Pub. Date: Jul. 10, 2025

(54) METHOD AND APPARATUS FOR HANDLING RADIO ACCESS TECHNOLOGY OR FREQUENCY SELECTION PRIORITY

(71) Applicant: TELEFONAKTIEBOLAGET LM ERICSSON (PUBL), Stockholm (SE)

(72) Inventors: JUYING GAN, Shanghai (CN); YUNJIE LU; MARIA BELEN PANCORBO MARCOS, Madrid (ES); ANTONIO INIESTA GONZALEZ, Madrid (ES); IGNACIO RIVAS MOLINA, Madrid (ES)

(21) Appl. No.: 18/850,716

(22) PCT Filed: Mar. 3, 2023
(86) PCT No.: PCT/CN2023/079514

§ 371 Date: Sep. 25, 2024

(30) Foreign Application Priority Data
Mar. 25, 2022 (WO) PCT/CN2022/083106

(51) Int. Cl. H04W 72/563; H04W 36/00; H04W 72/02; H04W 72/0453

(52) U.S. Cl. CPC H04W 72/563; H04W 36/0022; H04W 72/02; H04W 72/0453

(57) ABSTRACT

Embodiments of the present disclosure provide methods and apparatuses for handling radio access technology or frequency selection priority (RFSP). A method performed by a policy control entity comprises setting a validity time for a radio access technology or frequency selection priority (RFSP) index for a User Equipment (UE) moving from the first network to a second network. The method further comprises sending a first message comprising the RFSP index and the validity time for the RFSP index to a mobility management entity in the first network. The validity time for the RFSP index indicates a time by which the RFSP index will be used in the second mobility management entity while the UE is in the second network.

### TECHNICAL FIELD

The non-limiting and exemplary embodiments of the present disclosure generally relate to the technical field of communications, and specifically to methods and apparatuses for handling radio access technology or frequency selection priority (RFSP).

### BACKGROUND

This section introduces aspects that may facilitate a better understanding of the disclosure. Accordingly, the statements of this section are to be read in this light and are not to be understood as admissions about what is in the prior art or what is not in the prior art.

In communication networks for example LTE (Long Term Evolution) and NR (new radio) as defined by 3rd Generation Partnership Project (3GPP), to support radio resource management in RAN (radio access network), a mobility management entity such as access and mobility function (AMF) or Mobile Management Entity (MME) may provide a parameter ‘Index to radio access technology (RAT)/Frequency Selection Priority’ (RFSP Index) to RAN (radio access network). The RFSP Index is mapped by the RAN to locally defined configuration in order to apply specific Radio Resource Management (RRM) strategies, taking into account any available information in RAN. The RFSP Index is user equipment (UE) specific and applies to all the Radio Bearers. Examples of how this parameter may be used by the RAN is to derive UE specific cell reselection priorities to control idle mode camping and/or to decide on redirecting active mode UEs to different frequency layers or RATs.

The mobility management entity such as AMF or MME may receive the subscribed RFSP Index from the data management node such as UDM (unified data management) or HSS (home subscriber server) (e.g. during the registration procedure). For non-roaming subscribers, the mobility management entity such as AMF or MME may choose the RFSP Index in use according to one of the following procedures, depending on operator's configuration:
the RFSP Index in use is identical to the subscribed RFSP Index, or
the AMF chooses the RFSP Index in use based on the subscribed RFSP Index, the locally configured operator's policies, the Allowed NSSAI (Network Slice Selection Assistance Information) and the UE related context information available at the AMF, including UE's usage setting, if received during Registration procedures.

One example of how the AMF can use the “UE's usage setting,” is to select an RFSP value that enforces idle mode camping on Evolved Universal Terrestrial Radio Access (E-UTRA) for a UE acting in a “Voice centric” way, in the case voice over NR is not supported in the specific Registration Area and it contains NR cells.

The AMF may report to the PCF (Policy Control Function) the subscribed RFSP Index received from the UDM for further evaluation. When receiving the authorized RFSP Index from the PCF, the AMF shall replace the subscribed RFSP Index with the authorized RFSP Index.

The AMF stores the subscribed RFSP Index value received and the RFSP Index value in use. During the Registration procedure, the AMF may update the RFSP Index value in use (e.g. the AMF may need to update the RFSP Index value in use if the UE related context information in the AMF has changed). When the RFSP Index value in use is changed, the AMF immediately provides the updated RFSP Index value in use to NG-RAN (next generation radio access network) node by modifying an existing UE context or by establishing a new UE context in RAN or by being configured to include the updated RFSP Index value in use in the next generation application protocol (NGAP) downlink non-access stratum (NAS) transport message if the user plane establishment is not needed.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There are some problems in the exiting RFSP handling solutions.

3GPP TR 23.700-89 V0.1.0, the disclosure of which is incorporated by reference herein in its entirety, includes the following key issue.

Key Issue #1: RFSP Index consistency when UE moves from 5GC (fifth generation core network) to EPC (Evolved Packet Core).

Currently, most operators run 4G (fourth generation) and 5G (fifth generation) merged network. To promote 5G service, the subscription data of UE may be set to 5G access first, i.e. the subscribed RFSP Index is of the value of “5G has higher priority than 4G”. In some scenarios, the PCF may adjust the RFSP index to direct the UE from 5G to 4G according to dynamic network situations.

For example, when network congestion prediction received from NWDAF (network data analytics function), the PCF may move some of the “5G prioritized” UEs which consuming low value applications to 4G access.

According to a request from AF (application function), the PCF may move the requested UE(s) from 5G to 4G.

When UE registers to EPC, the MME chooses the RFSP Index in use based on the subscribed RFSP Index, the locally configured operator's policies and the UE related context information available at the MME. If the EPC decides the UE needs to go back to 5G, the MME provides “5G prioritized” RFSP Index to eNB (evolved NodeB).

To avoid network issue, e.g., the ping-pong issue, where the 5GC keeps sending the UE to EPC based on authorized RFSP Index from PCF, while the MME only has the subscribed RFSP Index and kick the UE in the above scenarios back to 5G immediately, this key issue will study AM (access and mobility) policy control on RFSP Index consistency when UE moves from 5GC to EPC:
Whether the current interworking procedure supports MME received the RFSP Index in use from 5GC? If no, what enhancements is needed.
If the MME get the RFSP Index in used in handover procedure or idle mode mobility procedure, how and when it resumes to the subscription RFSP Index.
When UE is under EPC, should MME receive any update of RFSP Index from 5GC and how.

As captured in the key issue of 3GPP TR 23.700-89 V0.1.0, there are two potential issues:

Issue 1. Ping-pong issue, i.e., UE in 5GS (5G system) is steered to Evolved Packet System (EPS) due to certain conditions (e.g. network congestion, application in use), then immediately steered back to 5GS.

Issue 2. Once the UE is steered to EPS (from 5GS), how to steer the UE back to 5GS when the conditions in 5GS in issue 1 above stop to apply.

Solution #1 in TR 23.700-89 v0.1.0 implies major change to the 5GS to EPS mobility procedure and intra-EPS mobility procedure.

To overcome or mitigate at least one above mentioned problems or other problems, the embodiments of the present disclosure propose an improved solution for handling RFSP.

In a first aspect of the disclosure, there is provided a method performed by a policy control entity. The method comprises setting a validity time for a radio access technology or frequency selection priority (RFSP) index for a User Equipment (UE) moving from the first network to a second network. The method further comprises sending a first message comprising the RFSP index and the validity time for the RFSP index to a mobility management entity in the first network. The validity time for the RFSP index indicates a time by which the RFSP index will be used in the second mobility management entity while the UE is in the second network.

In an embodiment, the method further comprises determining a change of a value of the RFSP index indicates a change from prioritizing a first network access to prioritizing a second network access for a user equipment. In response to said determining, the validity time for the RFSP index is comprised in the first message.

In an embodiment, the first network comprises 3rd Generation Partnership Project (3GPP) fifth generation system (5GS) and the second network comprises 3GPP Evolved Packet System (EPS).

In an embodiment, the first message comprises at least one of an access and mobility management entity policy control create response, or an access and mobility management entity policy control update notify.

In an embodiment, the policy control entity comprises Policy Control Function (PCF).

In an embodiment, the mobility management entity comprises access and mobility function (AMF).

In an embodiment, the second mobility management entity is Mobile Management Entity (MME).

In an embodiment, the RFSP index indicates prioritizing 3GPP EPS access.

In a second aspect of the disclosure, there is provided method performed by a first mobility management node. The method comprises sending to a second mobility management entity in a second network, a second message comprising a radio access technology or frequency selection priority (RFSP) index and a validity time for the RFSP index for a User Equipment (UE) moving from the first network to a second network. The validity time for the RFSP index indicates a time by which the RFSP index will be used in the second mobility management entity while the UE is in the second network.

In an embodiment, the first network comprises 3rd Generation Partnership Project (3GPP) fifth generation system (5GS) and the second network comprises 3GPP Evolved Packet System (EPS).

In an embodiment, the method further comprises receiving a first message comprising the RFSP index and the validity time for the RFSP index from a policy control entity. The method further comprises storing the validity time for the RFSP index.

In an embodiment, the first message comprises at least one of an access and mobility management entity policy control create response, or an access and mobility management entity policy control update notify.

In an embodiment, the policy control entity comprises Policy Control Function (PCF).

In an embodiment, the first mobility management entity is access and mobility function (AMF) and the second mobility management entity is Mobile Management Entity (MME).

In an embodiment, the second message is sent to the second mobility management entity during at least one of a procedure of 5GS to EPS handover using N26 interface, or a procedure of 5GS to EPS Idle mode mobility using N26 interface.

In an embodiment, the second message comprises at least one of a Forward Relocation Request, or a Context Response.

In an embodiment, the RFSP index indicates prioritizing 3GPP EPS access.

In a third aspect of the disclosure, there is provided method performed by a second mobility management node. The method comprises receiving from a first mobility management entity in a first network, a second message comprising a radio access technology or frequency selection priority (RFSP) index and a validity time for the RFSP index for a User Equipment (UE) moving from the first network to the second network. The validity time for the RFSP index indicates a time by which the RFSP index will be used in the second mobility management entity while the UE is in the second network. The method further comprises using the RFSP index for a period of time indicated by the validity time until the validity time expires.

In an embodiment, the method further comprises when the validity time for the RFSP index expires, performing RFSP index re-evaluation.

In an embodiment, the method further comprises storing the RFSP index and the validity time for the RFSP index.

In an embodiment, the second message comprises at least one of a Forward Relocation Request, or a Context Response.

In an embodiment, the first mobility management entity is access and mobility function (AMF) and the second mobility management entity is Mobile Management Entity (MME).

In an embodiment, the second message is received from the first mobility management entity during at least one of a procedure of 5GS to EPS handover using N26 interface, or a procedure of 5GS to EPS Idle mode mobility using N26 interface.

In an embodiment, the RFSP index indicates prioritizing 3GPP EPS access.

In a fourth aspect of the disclosure, there is provided a policy control node. The policy control node comprises a processor and a memory coupled to the processor. Said memory contains instructions executable by said processor. Said policy control node is operative to set a validity time for a radio access technology or frequency selection priority (RFSP) index for a User Equipment (UE) moving from a first network to a second network. Said policy control node is further operative to send a first message comprising the RFSP index and the validity time for the RFSP index to a mobility management entity in the first network. The validity time for the RFSP index indicates a time by which the RFSP index will be used in the second mobility management entity while the UE is in the second network.

In a fifth aspect of the disclosure, there is provided first mobility management node, comprises a processor and a memory coupled to the processor. Said memory contains instructions executable by said processor. Said first mobility management node is operative to send to a second mobility management entity in a second network, a second message comprising a radio access technology or frequency selection priority (RFSP) index and a validity time for the RFSP index for a User Equipment (UE) moving from the first network to a second network. The validity time for the RFSP index indicates a time by which the RFSP index will be used in the second mobility management entity while the UE is in the second network.

In a sixth aspect of the disclosure, there is provided a second mobility management node. The second mobility management node comprises a processor and a memory coupled to the processor. Said memory contains instructions executable by said processor. Said second mobility management node is operative to receive from a first mobility management entity in a first network, a second message comprising a radio access technology or frequency selection priority (RFSP) index and a validity time for the RFSP index for a User Equipment (UE) moving from the first network to the second network. The validity time for the RFSP index indicates a time by which the RFSP index will be used in the second mobility management entity while the UE is in the second network. Said second mobility management node is further operative to use the RFSP index for a period of time indicated by the validity time until the validity time expires.

In a seventh aspect of the disclosure, there is provided a policy control node. The policy control node comprises a setting module configured to set a validity time for a radio access technology or frequency selection priority (RFSP) index for a User Equipment (UE), moving from the first network to a second network. The validity time for the RFSP index may indicate a time by which the RFSP index will be used in the second mobility management entity while the UE is in the second network. The policy control entity further comprises a sending module configured to send a first message comprising the RFSP index and the validity time for the RFSP index to a mobility management entity in the first network.

In an embodiment, the policy control entity further comprises a determining module configured to determine a change of a value of the RFSP index indicates a change from prioritizing a first network access to prioritizing a second network access for a user equipment. In response to said determining, the validity time for the RFSP index is comprised in the first message.

In an eighth aspect of the disclosure, there is provided a first mobility management node. The first mobility management node comprises a sending module configured to send to a second mobility management entity in a second network, a second message comprising a radio access technology or frequency selection priority (RFSP) index and a validity time for the RFSP index for a User Equipment (UE) moving from the first network to a second network. The validity time for the RFSP index may indicate a time by which the RFSP index will be used in the second mobility management entity while the UE is in the second network.

In an embodiment, the first mobility management entity further comprises a first receiving module configured to receive the RFSP index from a policy control entity.

In an embodiment, the first mobility management entity further comprises a determining module configured to determine a change of a value of the RFSP index indicates a change from prioritizing a first network access to prioritizing a second network access for a user equipment.

In an embodiment, the first mobility management entity further comprises a setting module configured to set the validity time for the RFSP index.

In an embodiment, the first mobility management entity further comprises a first storing module configured to store the validity time for the RFSP index.

In an embodiment, the first mobility management entity further comprises a second receiving module configured to receive a first message comprising the RFSP index and the validity time for the RFSP index from a policy control entity.

In an embodiment, the first mobility management entity further comprises a second storing module configured to store the validity time for the RFSP index.

In a ninth aspect of the disclosure, there is provided a second mobility management node. The second mobility management node comprises a receiving module configured to receive from a first mobility management entity in a first network, a second message comprising a radio access technology or frequency selection priority (RFSP) index and a validity time for the RFSP index for a User Equipment (UE) moving from the first network to the second network. The validity time for the RFSP index may indicate a time by which the RFSP index will be used in the second mobility management entity while the UE is in the second network. The second mobility management entity further comprises a using module configured to use the RFSP index for a period of time indicated by the validity time until the validity time expires.

In an embodiment, the second mobility management entity further comprises a storing module configured to store the RFSP index and the validity time for the RFSP index.

In an embodiment, the second mobility management entity further comprises a performing module configured to perform RFSP index re-evaluation when the validity time for the RFSP index expires.

In a tenth aspect of the disclosure, there is provided a computer-readable storage medium storing instructions which when executed by at least one processor, cause the at least one processor to perform any of the methods according to the first, second and third aspects of the disclosure.

In an eleventh aspect of the disclosure, there is provided a computer program product, comprising instructions which, when executed on at least one processor, cause the at least one processor to carry out any of the methods according to the first, second and third aspects of the disclosure.

Many advantages may be achieved by applying the proposed solution according to embodiments of the present disclosure. For example, in some embodiments herein, a benefit is that the UE is allowed to be directed back to a network such as 5GS after the configurable/validity time expires. In some embodiments herein, the ping-pong issue can be alleviated with minimal impact to the first network such as 5GS and the second network such as EPS. In some embodiments herein, the proposed solution can keep the impact to the first network such as 5GS and the second network such as EPS minimal. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a schematically shows a high level architecture in the fifth generation network according to an embodiment of the present disclosure;

FIG. 1b schematically shows architecture for migration scenario for EPC and 5G CN according to an embodiment of the present disclosure;

FIG. 1c schematically shows non-roaming architecture for interworking between 5GS and EPC/E-UTRAN according to an embodiment of the present disclosure;

FIG. 2a a flowchart of 5GS to EPS handover for single-registration mode with N26 according to an embodiment of the present disclosure;

FIG. 2b a flowchart of 5GS to EPS Idle mode mobility using N26 interface according to an embodiment of the present disclosure;

FIG. 2c a flowchart of AM Policy Association Establishment with new selected PCF according to an embodiment of the present disclosure;

FIG. 2d a flowchart of AM Policy Association Modification initiated by the PCF according to an embodiment of the present disclosure;

FIG. 3 shows a flowchart of a method according to an embodiment of the present disclosure;

FIG. 4 shows a flowchart of a method according to another embodiment of the present disclosure;

FIG. 5 shows a flowchart of a method according to another embodiment of the present disclosure;

FIG. 6 shows a flowchart of a method according to another embodiment of the present disclosure;

FIG. 7 shows a flowchart of a method according to another embodiment of the present disclosure;

FIG. 8 shows a flowchart of a method according to another embodiment of the present disclosure;

FIG. 9 is a block diagram showing an apparatus suitable for practicing some embodiments of the disclosure;

FIG. 10 is a block diagram showing a policy control entity in a first network according to an embodiment of the disclosure;

FIG. 11 is a block diagram showing a first mobility management entity in a first network according to an embodiment of the disclosure; and

FIG. 12 is a block diagram showing a second mobility management entity in a second network according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced (LTE-A), wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” refers to any suitable network function (NF) which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The network device may be an access network device with accessing function in a communication network via which a terminal device accesses to the network and receives services therefrom. The access network device may include a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), an Integrated Access and Backhaul (IAB) node, a remote radio head (RRH), a relay, a low power node such as a femto, a pico, and so forth.

Yet further examples of the access network device comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

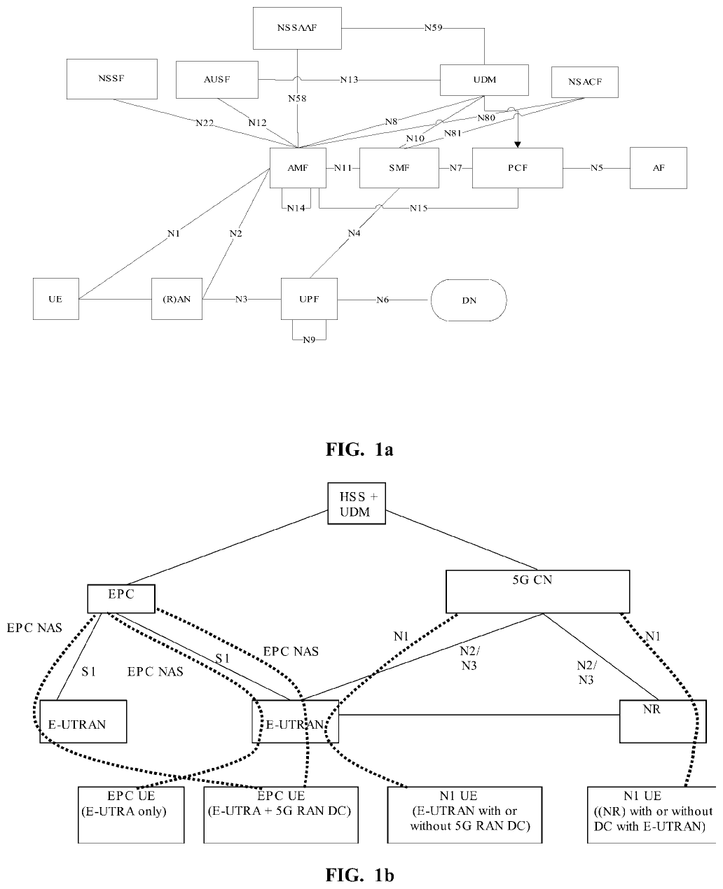

Although the subject matter described herein may be implemented in any appropriate type of system using any suitable components, the embodiments disclosed herein are described in relation to a communication system complied with the exemplary system architectures illustrated in FIGS. 1a-1c. For simplicity, the system architectures of FIGS. 1a-1c only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

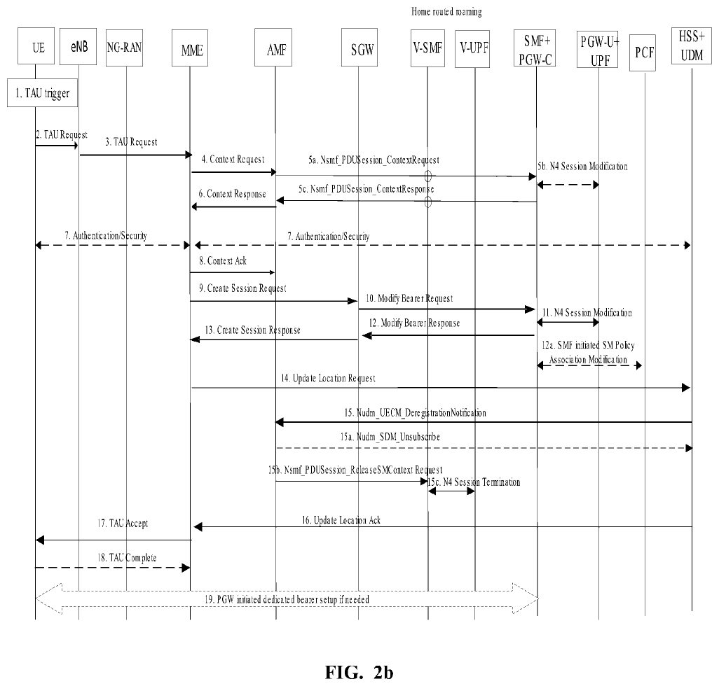

FIG. 1a schematically shows a high level architecture in the fifth generation network according to an embodiment of the present disclosure. For example, the fifth generation network may be 5GS. The architecture of FIG. 1a is same as Figure 4.2.3-2 as described in 3GPP TS 23.501 V17.2.0, the disclosure of which is incorporated by reference herein in its entirety. The system architecture of FIG. 1a may comprise some exemplary elements such as AUSF, AMF, DN (data network), NEF, NRF, NSSF, PCF, SMF, UDM, UPF, AF, UE, (R) AN, SCP (Service Communication Proxy), NSSAAF (Network Slice-Specific Authentication and Authorization Function), NSACF (Network Slice Admission Control Function), etc.

In accordance with an exemplary embodiment, the UE can establish a signaling connection with the AMF over the reference point N1, as illustrated in FIG. 1a. This signaling connection may enable NAS (Non-access stratum) signaling exchange between the UE and the core network, comprising a signaling connection between the UE and the (R) AN and the N2 connection for this UE between the (R) AN and the AMF. The (R) AN can communicate with the UPF over the reference point N3. The UE can establish a protocol data unit (PDU) session to the DN (data network, e.g. an operator network or Internet) through the UPF over the reference point N6.

As further illustrated in FIG. 1a, the exemplary system architecture also contains some reference points such as N1, N2, N3, N4, N6, N9, N15, etc., which can support the interactions between NF services in the NFs. For example, these reference points may be realized through corresponding NF service-based interfaces and by specifying some NF service consumers and providers as well as their interactions in order to perform a particular system procedure. The AM related policy is provided by PCF to AMF for a registered UE via N15 interface. AMF can get AM policy during AM Policy Association Establishment/Modification procedure.

Various NFs shown in FIG. 1a may be responsible for functions such as session management, mobility management, authentication, security, etc. The AUSF, AMF, DN, NEF, NRF, NSSF, PCF, SMF, UDM, UPF, AF, UE, (R) AN, SCP, NSACF may include the functionality for example as defined in clause 6.2 of 3GPP TS 23.501 V17.2.0.

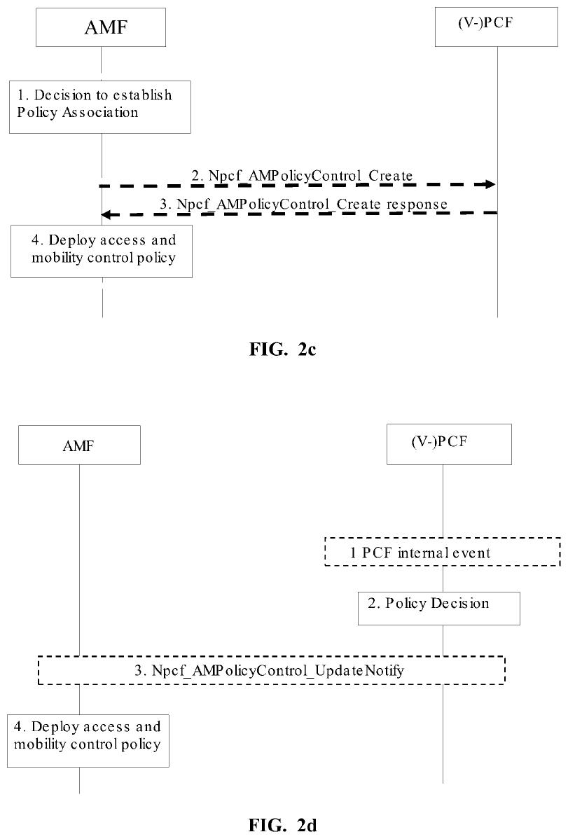

FIG. 1b schematically shows architecture for migration scenario for EPC and 5G CN (core network) according to an embodiment of the present disclosure, which is the same as Figure 5.17.1.1-1 of 3GPP TS 23.501 V17.2.0.

Deployments based on different 3GPP architecture options (i.e. EPC based or 5GC based) and UEs with different capabilities (EPC NAS and 5GC NAS) may coexist at the same time within one PLMN.

It is assumed that a UE that is capable of supporting 5GC NAS procedures may also be capable of supporting EPC NAS (i.e. the NAS procedures defined in 3GPP TS 23.401 V17.3.0, the disclosure of which is incorporated by reference herein in its entirety) to operate in legacy networks e.g. in the case of roaming.

The UE will use EPC NAS or 5GC NAS procedures depending on the core network by which it is served.

In order to support smooth migration, it is assumed that the EPC and the 5GC have access to a common subscriber database, that is HSS in the case of EPC and the UDM in the case of 5GC, acting as the master data base for a given user as defined in 3GPP TS 23.002 V17.0.0, the disclosure of which is incorporated by reference herein in its entirety. The PCF has access to the UDR (Unified Data Repository) that acts as a common subscriber database for a given user identified by a SUPI using the Nudr services defined in 3GPP TS 23.502 V17.2.1, the disclosure of which is incorporated by reference herein in its entirety.

A UE that supports only EPC based Dual Connectivity with secondary RAT NR:
always performs initial access through E-UTRA (LTE-Uu) but never through NR;
performs EPC NAS procedures over E-UTRA (i.e. Mobility Management, Session Management etc) as defined in 3GPP TS 24.301 V17.5.0, the disclosure of which is incorporated by reference herein in its entirety.

A UE that supports camping on 5G Systems with 5GC NAS:
performs initial access either through E-UTRAN that connects to 5GC or NR towards 5GC;
performs initial access through E-UTRAN towards EPC, if supported and needed;
performs EPC NAS or 5GC NAS procedures over E-UTRAN or NR respectively (i.e. Mobility Management, Session Management etc.) depending on whether the UE requests 5GC access or EPC access, if the UE also supports EPC NAS.

Clause 5.17.2.2 of 3GPP TS 23.501 V17.2.0 describes interworking procedures with N26 interface. Interworking procedures using the N26 interface, enables the exchange of MM and SM states between the source and target network. The N26 interface may be either intra-PLMN (Public Land Mobile Network) or inter-PLMN (e.g. to enable inter-PLMN mobility). When interworking procedures with N26 is used, the UE operates in single-registration mode. For the 3GPP access, the network keeps only one valid MM (mobility management) state for the UE, either in the AMF or MME. For the 3GPP access, either the AMF or the MME is registered in the HSS+UDM.

The support for N26 interface between AMF in 5GC and MME in EPC is required to enable seamless session continuity (e.g. for voice services) for inter-system change.

Clause 5.17.2.3 of 3GPP TS 23.501 V17.2.0 describes interworking procedures without N26 interface. For interworking without the N26 interface, IP address preservation is provided to the UEs on inter-system mobility by storing and fetching SMF+PGW-C and corresponding APN/DNN information via the HSS+UDM. In such networks AMF also provides an indication that interworking without N26 is supported to UEs during Initial Registration in 5GC or MME may optionally provide an indication that interworking without N26 is supported in the Attach procedure in EPC as defined in 3GPP TS 23.502 V17.2.1 and 3GPP TS 23.401 V17.3.0. The UE provides an indication that it supports Request Type flag “handover” for PDN connectivity request during the attach procedure as described in clause 5.3.2.1 of 3GPP TS 23.401 V17.3.0 and during initial Registration and Mobility Registration Update in 5GC.

FIG. 1c schematically shows non-roaming architecture for interworking between 5GS and EPC/E-UTRAN according to an embodiment of the present disclosure, which is the same as Figure 4.3.1-1 of 3GPP TS 23.501 V17.2.0.

N26 interface is an inter-CN interface between the MME and 5GS AMF in order to enable interworking between EPC and the NG core. Support of N26 interface in the network is optional for interworking. N26 supports subset of the functionalities (essential for interworking) that are supported over S10.

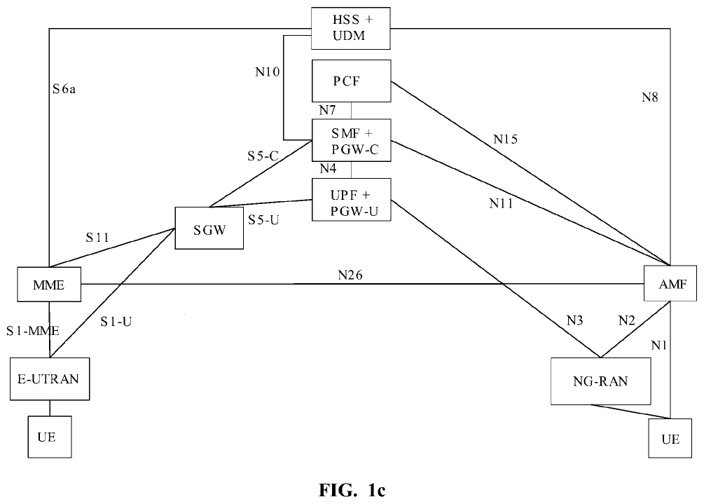

FIG. 2a a flowchart of 5GS to EPS handover for single-registration mode with N26 according to an embodiment of the present disclosure, which is the same as Figure 4.11.1.2.1-1 of 3GPP TS 23.502 V17.2.1.

As described in clause 4.11.1.2.1 of 3GPP TS 23.502 V17.2.1, at step 3. The AMF sends a Forward Relocation Request as in step 3 in clause 5.5.1.2.2 (S1-based handover, normal) in 3GPP TS 23.401 V17.3.0, with the following modifications and clarifications:
Parameter “Return preferred” may be included. Return preferred is an optional indication by the MME of a preferred return of the UE to the 5GS PLMN at a later access change to a 5GS shared network. An MME may use this information as specified by 3GPP TS 23.501 V17.2.0.
The SGW address and TEID for both the control-plane or EPS bearers in the message are such that target MME selects a new SGW.
The AMF determines, based on configuration and the Direct Forwarding Path Availability, the Direct Forwarding Flag to inform the target MME whether direct data forwarding is applicable.
The AMF includes the mapped SM EPS UE Contexts for PDU Sessions with and without active UP connections.
Subject to operator policy if the secondary RAT access restriction condition is the same for EPS and 5GS, the AMF may set EPS secondary RAT access restriction condition based on the UE's subscription data.

The description of other steps can refer to clause 4.11.1.2.1 of 3GPP TS 23.502 V17.2.1.

FIG. 2b a flowchart of 5GS to EPS Idle mode mobility using N26 interface according to an embodiment of the present disclosure, which is the same as Figure 4.11.1.3.2-1 of 3GPP TS 23.502 V17.2.1.

As described in clause 4.11.1.3.2 of 3GPP TS 23.502 V17.2.1, at step 6. The AMF responds with a Context Response message carrying mapped MM context (including mapped security context), Return preferred and SM EPS UE Context (default and dedicated GBR (Guaranteed Bit Rate) bearers) to the MME. If the verification of the integrity protection fails, the AMF returns an appropriate error cause. Return preferred is an optional indication by the AMF of a preferred return of the UE to the 5GS PLMN at a later access change to a 5GS shared network. The AMF may start an implementation specific (guard) timer for the UE context.

From the received context and the Tracking Area indicated by the RAN, the MME can determine whether the UE is performing Inter-RAT mobility to or from NB-IoT.

The description of other steps can refer to clause 4.11.1.3.2 of 3GPP TS 23.502 V17.2.1.

FIG. 2c a flowchart of AM Policy Association Establishment with new selected PCF according to an embodiment of the present disclosure, which is the same as Figure 4.16.1.2-1 of 3GPP TS 23.502 V17.2.1.

As described in clause 4.16.1 of 3GPP TS 23.502 V17.2.1, there are three cases considered for AM Policy Association Establishment:
1. UE initial registration with the network.
2. The AMF re-allocation with PCF change in handover procedure and registration procedure.
3. EPS to 5GS mobility when there is no existing AM Policy Association between AMF and PCF for this UE.

This procedure concerns both roaming and non-roaming scenarios.

In the non-roaming case the role of the V-PCF (visited PCF) is performed by the PCF. For the roaming scenarios, the V-PCF interacts with the AMF.

At step 1. Based on local policies, the AMF decides to establish AM Policy Association with the (V-)PCF then steps 2 to 3 are performed under the conditions described below.

At step 2. [Conditional] If the AMF has not yet obtained Access and Mobility policy for the UE or if the Access and Mobility policy in the AMF are no longer valid, the AMF requests the PCF to apply operator policies for the UE from the PCF. The AMF sends Npcf_AMPolicyControl_Create to the (V-)PCF to establish an AM policy control association with the (V-)PCF. The request includes the following information: SUPI, Internal Group (see clause 5.9.7 of 3GPP TS 23.501 V17.2.0), subscription notification indication and, if available, Service Area Restrictions, RESP index, Subscribed UE-AMBR, List of Subscribed UE-Slice-MBR, the Allowed NSSAI, Target NSSAI (see clause 5.3.4.3.3 of 3GPP TS 23.501 V17.2.0), GPSI which are retrieved from the UDM during the update location procedure, and may include Access Type and RAT Type, PEI, ULI, UE time zone, and Serving Network (PLMN ID, or PLMN ID and NID, see clause 5.34 of 3GPP TS 23.501 V17.2.0).

When AMF utilizes an NWDAF, it may add the NWDAF serving the UE identified by the NWDAF instance ID. Per NWDAF service instance the Analytics ID(s) are also included.

At step 3. The (V)-PCF responds to the Npcf_AMPolicyControl_Create service operation. The (V)-PCF provides Access and mobility related policy information (e.g. Service Area Restrictions) as defined in clause 6.5 of 3GPP TS 23.503 V17.3.0. In addition, (V)-PCF can provide Policy Control Request Trigger of AM Policy Association to AMF. In the non-roaming case, the PCF may subscribe to Analytics from NWDAF as defined in clause 6.1.1.3 of 3GPP TS 23.503 V17.3.0.

The AMF is implicitly subscribed in the (V-)PCF to be notified of changes in the policies.

The (V-)PCF may register to the BSF as the PCF that handles the AM Policy Association for this UE. This is performed by using the Nbsf_Management Register operation, providing as inputs the UE SUPI/GPSI and the PCF identity.

At step 4. [Conditional] The AMF deploys the Access and mobility related policy information which includes storing the Service Area Restrictions and Policy Control Request Trigger of AM Policy Association, provisioning Service Area Restrictions to the UE and provisioning the RFSP index, the UE-AMBR, List of UE-Slice-MBR, Service Area Restrictions to the NG-RAN as defined in 3GPP TS 23.501 V17.2.0 and request for notification of SM Policy association establishment and termination to a list of (DNN, S-NSSAI)(s) together with PCF for the UE binding.

FIG. 2d a flowchart of AM Policy Association Modification initiated by the PCF according to an embodiment of the present disclosure, which is the same as Figure 4.16.2.2-1 of 3GPP TS 23.502 V17.2.1.

As described in clause 4.16.1 of 3GPP TS 23.502 V17.2.1, the AM Policy Association modification procedure may be initiated by an internal PCF event or by PCF obtaining pertinent analytics information from an NWDAF.

The following procedure is applicable to AM Policy Association modification due to Case B.

The procedure driven by a PCF internal event applies to concerns both roaming and non-roaming scenarios and when driven by NWDAF, applies only to non-roaming scenarios.

An AM Policy Association is established, with the V-PCF in case of roaming or with the PCF in a non-roaming case as described in clause 4.16.1.2 of 3GPP TS 23.502 V17.2.1 before this procedure is triggered.

In the non-roaming case the role of the V-PCF is performed by the PCF. For the roaming scenarios, the V-PCF interacts with the AMF.

NOTE: The V-PCF/PCF stores the access and mobility control policy information provided to the AMF.

At step 1. [Conditional] The PCF determines internally that the new status of the UE context requires new policies, potentially triggered by an AF as described in clause 4.15.6.9 or by a notification from the UDR. This may be triggered by obtaining pertinent analytics information from an NWDAF as described in clause 6.1.1.3 of 3GPP TS 23.503 V17.3.0.

At step 2. The (V-)PCF in case of roaming and PCF in a non-roaming case makes a policy decision. The PCF may also decide to subscribe to a new Analytics ID from NWDAF as described in clause 6.1.1.3 of 3GPP TS 23.503 V17.3.0.

At step 3. The (V-)PCF in the roaming case and the PCF in a non-roaming case sends Npcf_AMPolicyControl_UpdateNotify including AM Policy Association ID associated with the SUPI defined in 3GPP TS 29.507. The policy update may include Service Area Restrictions, UE-AMBR, RESP index value, access stratum time distribution indication and Uu time synchronization error budget. If an AF has previously subscribed to event request for allocation of service area coverage outcome in step 1, the (V-)PCF checks if the allocated service area coverage was changed and sends a respective notification to the AF using Npcf_AMPolicyAuthorization_Notify as defined in clause 6.3.1.18 in 3GPP TS 23.503 V17.3.0.

At step 4. The AMF deploys and stores the updated Access and mobility related policy information, which includes storing the Service Area Restrictions and Policy Control Request Trigger of AM Policy Association, provisioning of the Service Area Restrictions to the UE, provisioning the RFSP index, UE-AMBR, Service Area Restrictions to the NG-RAN, optionally the access stratum time distribution indication and Uu time synchronization error budget to the NG-RAN and request for notification of SM Policy association establishment and termination to a list of (DNN, S-NSSAI) (s) together with PCF for the UE binding information.

Clause 4.3.6 of 3GPP TS 23.401 V17.3.0 describes radio resource management functions.

To support radio resource management in E-UTRAN the MME provides the parameter ‘Index to RAT/Frequency Selection Priority’ (RFSP Index) to an eNodeB across S1. The RFSP Index is mapped by the eNodeB to locally defined configuration in order to apply specific RRM strategies. The RFSP Index is UE specific and applies to all the Radio Bearers. Examples of how this parameter may be used by the E-UTRAN:
to derive UE specific cell reselection priorities to control idle mode camping.
to decide on redirecting active mode UEs to different frequency layers or RATs.

The MME receives the subscribed RFSP Index and subscribed ARPI from the HSS (e.g., during the Attach procedure). For non-roaming subscribers the MME chooses the RFSP Index and ARPI in use according to one of the following procedures, depending on operator's configuration:
the RFSP Index in use is identical to the subscribed RFSP Index, or
the MME chooses the RFSP Index in use based on the subscribed RFSP Index, the locally configured operator's policies and the UE related context information available at the MME, including UE's usage setting and voice domain preference for E-UTRAN, if received during Attach and Tracking Area Update procedures (see clause 4.3.5.9 of 3GPP TS 23.401 V17.3.0).
the ARPI In Use is identical to the subscribed ARPI, or
the MME chooses the ARPI in use based on the subscribed ARPI, the locally configured operator's policies and the UE related context information available at the MME.

For roaming subscribers the MME may alternatively choose the RFSP Index and ARPI in use based on the visited network policy, but can take input from the HPLMN into account (e.g., an RFSP Index value/ARPI value pre-configured per HPLMN, or a single RFSP Index value/single ARPI value to be used for all roamers independent of the HPLMN).

The MME forwards the RFSP Index and ARPI in use to the eNodeB across S1. The RFSP Index and ARPI in use is also forwarded from source eNodeB to target eNodeB when X2 is used for intra-E-UTRAN handover, UE context retrieval, or, Dual Connectivity with a secondary RAN node.

The MME stores the subscribed RFSP Index and ARPI values received from the HSS and the RFSP Index and ARPI values in use. During the Tracking Area Update procedure, the MME may update the RFSP Index/ARPI value in use (e.g. the MME may need to update the RFSP Index/ARPI value in use if the UE related context information in the MME has changed). When the RFSP Index/ARPI value in use is changed, the MME immediately provides the updated RFSP Index/ARPI value in use to eNodeB by modifying an existing UE context or by establishing an new UE context in the eNodeB or by being configured to include the updated RFSP Index/ARPI value in use in the DOWNLINK NAS TRANSPORT message if the user plane establishment is not needed. During inter-MME mobility procedures, the source MME forwards both RFSP Index values and both ARPI values to the target MME. The target MME may replace the received RFSP Index and ARPI values in use with a new RESP Index value in use or new ARPI value in use that is based on the operator's policies and the UE related context information available at the target MME.

The S1 messages that transfer the RFSP Index and ARPI to the eNodeB are specified in 3GPP TS 36.413. Refer to 3GPP TS 36.300 for further information on E-UTRAN.

To support a RAN with a mixture of RAN nodes that support and do not support the ARPI, the MME sends the ARPI In Use in the SI interface PATCH SWITCH ACKNOWLEDGEMENT and HANDOVER REQUEST messages.

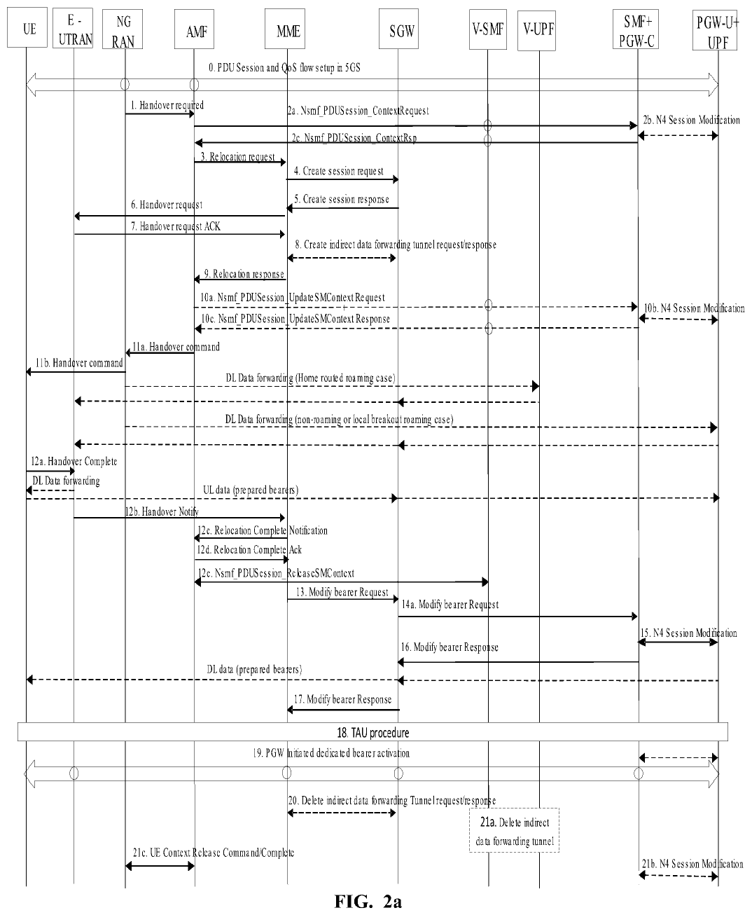

FIG. 3 shows a flowchart of a method according to an embodiment of the present disclosure, which may be performed by an apparatus implemented in/as or communicatively coupled to a policy control entity. As such, the apparatus may provide means for accomplishing various parts of the method 300 as well as means for accomplishing other processes in conjunction with other components.

At block 302, the policy control entity may set a validity time for a radio access technology or frequency selection priority (RFSP) index for a User Equipment (UE) moving from the first network to a second network.

In an embodiment, the policy control entity may be in a first network.

In an embodiment, the policy control entity may set a validity time for a radio access technology or frequency selection priority (RFSP) index. The validity time for the RFSP index indicates a time by which the RFSP index will take effect or be used. In an embodiment, the validity time for the RFSP index indicates a time by which the RFSP index will take effect or be used when a UE is in EPS.

In an embodiment, the validity time for the RFSP index indicates a time by which the RFSP index will be used in the second mobility management entity while the UE is in the second network.

At block 304, the policy control entity may send a first message comprising the RFSP index and the validity time for the RFSP index to a mobility management entity in the first network.

In an embodiment, the policy control entity comprises Policy Control Function (PCF). In an embodiment, the mobility management entity comprises access and mobility function (AMF). In an embodiment, the second mobility management entity is Mobile Management Entity (MME).

In an embodiment, the policy control entity may send a first message comprising the RFSP index and the validity time for the RFSP index to a mobility management entity.

The term “take effect” may mean that the mobility management entity should directly use the RFSP index before the validity time for the RFSP index is expired. For example, the mobility management entity should not re-evaluate or reselect the RFSP index.

The policy control entity may be any suitable network function which can provide policy control function. In an embodiment, the policy control entity comprises Policy Control Function (PCF).

The mobility management entity may be any suitable network function which can provide mobility management function. In an embodiment, the mobility management entity comprises access and mobility function (AMF).

The validity time for the RFSP index may be determined or obtained in various ways. For example, the validity time for the RFSP index may be provided to the policy control entity by an application node such as an application function or application server, etc. The validity time for the RFSP index may be determined by the policy control entity according to some criteria. A RFSP index may be configured with a fixed validity time. Different RFSP indexes may have different validity times. The validity time for the RFSP index may be determined according to a policy or rule. The validity time for the RFSP index may be configured by an operator. The validity time for the RFSP index may be determined based on subscription data of a subscriber. The validity time for the RFSP index may be determined according to service type, quality of service requirement or data volume of a UE. The validity time for the RFSP index may be determined based on the application in use. The validity time for the RFSP index may be determined according to network situation.

In an embodiment, a RFSP index may not have validity time (i.e., the RFSP index has no expiration time).

The validity time for the RFSP index may take any suitable forms such as timestamp.

The RFSP index may be set to any suitable value. There may be a mapping relationship from RFSP index to cell selection and the RAT/Frequency Priorities. The policy control entity may store or know the mapping relationship.

In an embodiment, the RFSP index indicates prioritizing 3GPP EPS access. In other embodiment, the RFSP index may indicate prioritizing any other suitable network access.

In an embodiment, the validity time for the RFSP index further indicates a time by which the RFSP index will take effect in a specific network. The specific network may be any suitable network such as 3GPP 2G, 3G, 4G network, etc. For example, when a UE is accessing to the specific network, the validity time for the RFSP index will take effect in the specific network. When the UE has accessed to another network rather than the specific network, the validity time for the RFSP index will not take effect in the specific network. In other words, the validity time for the RFSP index may be ignored in other network.

In an embodiment, the specific network comprises 3GPP EPS.

The first message may be any suitable message such as an existing message or a new message.

In an embodiment, the first message comprises at least one of an access and mobility management entity policy control create response, or an access and mobility management entity policy control update notify.

For example, as shown in FIG. 2c, during a procedure of AM Policy Association Establishment with new selected PCF, the RFSP index and the validity time for the RFSP index may be comprised in Npcf_AMPolicyControl_Create Response. As shown in FIG. 2d, during a procedure of AM Policy Association Modification initiated by the PCF, the RFSP index and the validity time for the RFSP index may be comprised in Npcf_AMPolicyControl_UpdateNotify.

The blocks 302 and 304 may be triggered to be performed due to various reasons.

As a first example, based on local policies, the mobility management entity such as AMF decides to establish AM policy association with the policy control entity, and then blocks 302 and 304 are performed under the conditions described below.

If the mobility management entity such as AMF has not yet obtained Access and Mobility policy for the UE or if the Access and Mobility policy in the mobility management entity such as AMF are no longer valid, the mobility management entity such as AMF requests the policy control entity such as PCF to apply operator policies for the UE from the policy control entity such as PCF. The mobility management entity such as AMF sends AM Policy Control Create request to the policy control entity to establish an AM policy control association with the policy control entity. The policy control entity sends to the mobility management entity the AM policy control create response which may include RFSP index and the validity time for the RFSP index.

As a second example, the AM Policy Association modification procedure may be initiated by an internal policy control entity event or by policy control entity obtaining pertinent analytics information from a network data analytics function, and then blocks 302 and 304 are performed under the conditions described below.

The policy control entity stores the access and mobility control policy information provided to the mobility management entity. The PCF determines internally that the new status of the UE context requires new policies, potentially triggered by an AF or by a notification from the unified data repository. This may be triggered by obtaining pertinent analytics information from a network data analytics function. The policy control entity makes a policy decision. The policy control entity sends AM policy control update notify which may include RFSP index and the validity time for the RFSP index.

FIG. 4 shows a flowchart of a method according to another embodiment of the present disclosure, which may be performed by an apparatus implemented in/as or communicatively coupled to a policy control entity. As such, the apparatus may provide means for accomplishing various parts of the method 400 as well as means for accomplishing other processes in conjunction with other components. For some parts which have been described in the above embodiments, the description thereof is omitted here for brevity.

At block 402, the policy control entity may determine a change of a value of the RFSP index indicates a change from prioritizing a first network access to prioritizing a second network access for a user equipment. In response to said determining, the validity time for the RFSP index is comprised in the first message.

The first network access may be any suitable RAT. The second network access may be any suitable RAT.

In an embodiment, the first network access comprises 3rd Generation Partnership Project (3GPP) fifth generation system (5GS) access and the second network access comprises 3GPP Evolved Packet System (EPS) access.

In an embodiment, the first network comprises 3rd Generation Partnership Project (3GPP) fifth generation system (5GS) and the second network comprises 3GPP Evolved Packet System (EPS).

For example, there may be a mapping relationship from RFSP index to cell selection and the RAT/Frequency Priorities. The policy control entity may store or know the mapping relationship. During AM policy association establishment with the policy control entity initiated by the mobility management entity or AM Policy association modification initiated by the PCF, the policy control entity may make access and mobility policy for a UE. The access and mobility policy may comprise an authorized RFSP index. The authorized RFSP index may be different the RFSP index provided by the mobility management entity. For example, the RFSP index provided by the mobility management entity may indicate prioritizing a first network access, while the authorized RFSP index may indicate prioritizing a second network access. Then the policy control entity may determine a change of a value of the RFSP index indicates a change from prioritizing a first network access to prioritizing a second network access for a user equipment.

At block 404, the policy control entity may set a validity time for a radio access technology or frequency selection priority (RFSP) index for a User Equipment (UE) moving from the first network to a second network. The validity time for the RFSP index indicates a time by which the RFSP index will be used in the second mobility management entity while the UE is in the second network. Block 404 is same as block 302 of FIG. 3.

At block 406, the policy control entity may send a first message comprising the RFSP index and the validity time for the RFSP index to a mobility management entity in the first network. Block 406 is same as block 304 of FIG. 3.

FIG. 5 shows a flowchart of a method according to another embodiment of the present disclosure, which may be performed by an apparatus implemented in/as or communicatively coupled to a first mobility management entity. As such, the apparatus may provide means for accomplishing various parts of the method 500 as well as means for accomplishing other processes in conjunction with other components. For some parts which have been described in the above embodiments, the description thereof is omitted here for brevity.

At block 502, the first mobility management entity may send to a second mobility management entity in a second network, a second message comprising a radio access technology or frequency selection priority (RFSP) index and a validity time for the RFSP index for a User Equipment (UE) moving from the first network to a second network.

In an embodiment, the first mobility management entity may be in a first network.

In an embodiment, the validity time for the RFSP index indicates a time by which the RFSP index will be used in the second mobility management entity while the UE is in the second network.

In an embodiment, the RFSP index indicates prioritizing 3GPP EPS access.

In an embodiment, the validity time for the RFSP index further indicates a time by which the RFSP index will take effect in a specific network.

In an embodiment, the specific network comprises 3GPP EPS.

The first mobility management entity may be any suitable network function which can provide mobility management function. For example, the first mobility management entity may be AMF or MME.

The second mobility management entity may be any suitable network function which can provide mobility management function. For example, the first mobility management entity may be AMF or MME.

In an embodiment, the first mobility management entity is AMF and the second mobility management entity is MME.

In an embodiment, the first mobility management entity is AMF and the second mobility management entity is AMF.

In an embodiment, the first mobility management entity is MME and the second mobility management entity is MME.

In an embodiment, the second message is sent to the second mobility management entity during at least one of a procedure of S1-based handover as described in clause 5.5.1.2 of 3GPP TS 23.401 V17.3.0 or a procedure of S1-based Dual Active Protocol Stacks (DAPS) handover as described in clause 5.5.1.2.2a of 3GPP TS 23.401 V17.3.0.

In an embodiment, the second message comprises at least one of a Forward Relocation Request or a Context Response as described in 3GPP TS 23.401 V17.3.0 and 3GPP TS 23.502 V17.2.1.

In an embodiment, the validity time for the RFSP index may be set by the first mobility management entity. For example, the RFSP index may be provided by the policy control entity and then the first mobility management entity set the validity time for the RFSP index. As another example, the first mobility management entity such as AMF or MME may choose the RFSP Index in use and then set the validity time for the RFSP index.

In another embodiment, the validity time for the RFSP index may be set and sent to the first mobility management entity by the policy control entity as described in methods 300 and 400.

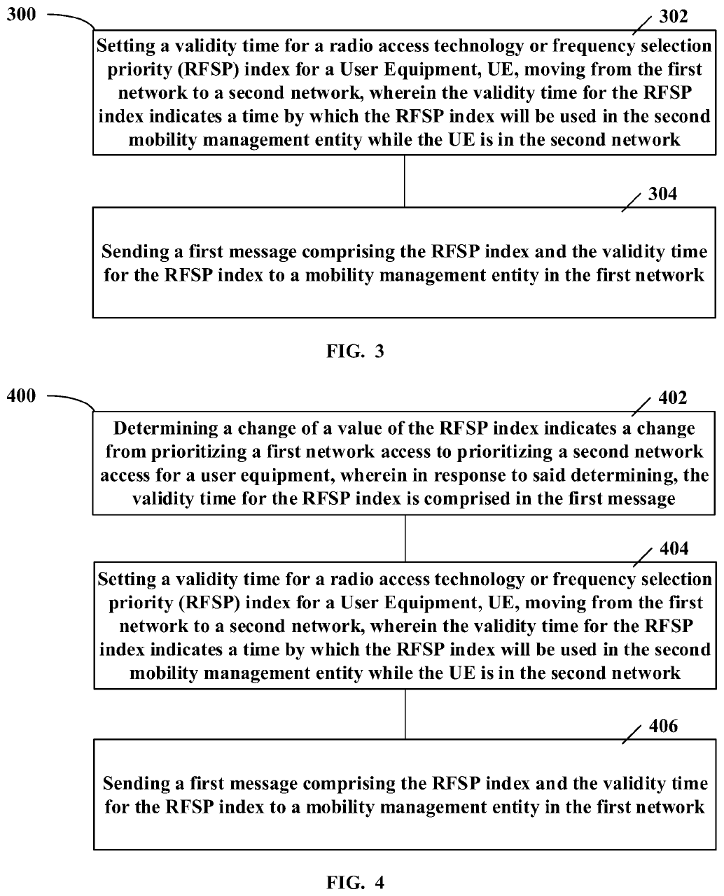

FIG. 6 shows a flowchart of a method according to another embodiment of the present disclosure, which may be performed by an apparatus implemented in/as or communicatively coupled to a first mobility management entity. As such, the apparatus may provide means for accomplishing various parts of the method 600 as well as means for accomplishing other processes in conjunction with other components. For some parts which have been described in the above embodiments, the description thereof is omitted here for brevity.

At block 602, the first mobility management entity may receive the RFSP index from a policy control entity. For example, the RFSP index may be an RFSP index authorized by the policy control entity. As described in FIGS. 2c and 2d, the AMF may receive the RFSP index from the PCF.

The policy control entity may be any suitable network function which can provide policy control function. In an embodiment, the policy control entity comprises Policy Control Function (PCF).

At block 604, the first mobility management entity may determine a change of a value of the RFSP index indicates a change from prioritizing a first network access to prioritizing a second network access for a user equipment.

The first network access may be any suitable RAT. The second network access may be any suitable RAT.

In an embodiment, the first network access comprises 3rd Generation Partnership Project (3GPP) fifth generation system (5GS) access and the second network access comprises 3GPP Evolved Packet System (EPS) access.

In an embodiment, the first network comprises 3rd Generation Partnership Project (3GPP) fifth generation system (5GS) and the second network comprises 3GPP Evolved Packet System (EPS).

For example, there may be a mapping relationship from RFSP index to cell selection and the RAT/Frequency Priorities. The first mobility management entity may store or know the mapping relationship. During AM policy association establishment with the policy control entity initiated by the mobility management entity or AM Policy association modification initiated by the PCF, the policy control entity may make access and mobility policy for a UE. The access and mobility policy may comprise an authorized RFSP index. The authorized RFSP index may be different the RFSP index provided by the mobility management entity. For example, the RFSP index provided by the mobility management entity may indicate prioritizing a first network access, while the authorized RFSP index may indicate prioritizing a second network access. Then the first mobility management entity may determine a change of a value of the RFSP index indicates a change from prioritizing a first network access to prioritizing a second network access for a user equipment.

At block 606, the first mobility management entity may set the validity time for the RFSP index.

The validity time for the RFSP index may be determined or obtained in various ways. For example, The validity time for the RFSP index may be determined by the first mobility management entity according to some criteria. A RFSP index may be configured with a fixed validity time. Different RFSP indexes may have different validity times. The validity time for the RFSP index may be determined according to a policy or rule. The validity time for the RFSP index may be configured by an operator. The validity time for the RFSP index may be determined based on subscription data of a subscriber. The validity time for the RFSP index may be determined according to service or data volume of a UE. The validity time for the RFSP index may be determined according to network situation.

In an embodiment, a RFSP index may not have validity time (i.e., the RFSP index has no expiration time).

The validity time for the RFSP index may take any suitable forms such as timestamp.

The RFSP index may be set any suitable value. There may be a mapping relationship from RFSP index to cell selection and the RAT/Frequency Priorities. The first mobility management entity may store or know the mapping relationship.

In an embodiment, the RFSP index indicates prioritizing 3GPP EPS access. In other embodiment, the RFSP index may indicate prioritizing any other suitable network access.

In an embodiment, the validity time for the RFSP index further indicates a time by which the RFSP index will take effect in a specific network. The specific network may be any suitable network such as 3GPP 2G, 3G, 4G network, etc. For example, when a UE is accessing to the specific network, the validity time for the RFSP index will take effect in the specific network. When the UE has accessed to another network rather than the specific network, the validity time for the RFSP index will not take effect in the specific network. In other words, the validity time for the RFSP index may be ignored in other network.

At block 608, the first mobility management entity may store the validity time for the RFSP index.

At block 610, the first mobility management entity may send to a second mobility management entity in a second network, a second message comprising a radio access technology or frequency selection priority (RFSP) index and a validity time for the RFSP index for a User Equipment (UE) moving from the first network to a second network. The validity time for the RFSP index indicates a time by which the RFSP index will be used in the second mobility management entity while the UE is in the second network.

In an embodiment, the first mobility management entity is access and mobility function (AMF) and the second mobility management entity is Mobile Management Entity (MME).

In an embodiment, the second message is sent to the second mobility management entity during at least one of a procedure of 5GS to EPS handover using N26 interface as described in clause 4.11.1.2.1 of 3GPP TS 23.502 V17.2.1 or a procedure of 5GS to EPS Idle mode mobility using N26 interface as described in clause 4.11.1.3.2 of 3GPP TS 23.502 V17.2.1.

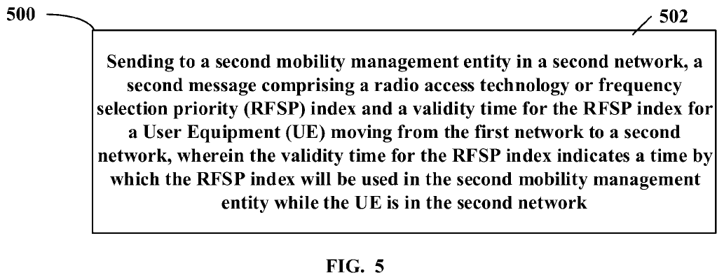

FIG. 7 shows a flowchart of a method according to another embodiment of the present disclosure, which may be performed by an apparatus implemented in/as or communicatively coupled to a first mobility management entity. As such, the apparatus may provide means for accomplishing various parts of the method 700 as well as means for accomplishing other processes in conjunction with other components. For some parts which have been described in the above embodiments, the description thereof is omitted here for brevity.

At block 702, the first mobility management entity may receive a first message comprising the RFSP index and the validity time for the RFSP index from a policy control entity. For example, as described in block 304 of FIG. 3 and block 406 of FIG. 4, the policy control entity may send the first message to the first mobility management entity, and then the first mobility management entity may receive the first message.

In an embodiment, the first message comprises at least one of an access and mobility management entity policy control create response or an access and mobility management entity policy control update notify.

At block 704, the first mobility management entity may store the validity time for the RFSP index.

At block 706, the first mobility management entity may send to a second mobility management entity in a second network, a second message comprising a radio access technology or frequency selection priority (RFSP) index and a validity time for the RFSP index for a User Equipment (UE) moving from the first network to a second network. In an embodiment, the validity time for the RFSP index indicates a time by which the RFSP index will be used in the second mobility management entity while the UE is in the second network.

In an embodiment, the first mobility management entity is access and mobility function (AMF) and the second mobility management entity is Mobile Management Entity (MME).

In an embodiment, the second message is sent to the second mobility management entity during at least one of a procedure of 5GS to EPS handover using N26 interface as described in clause 4.11.1.2.1 of 3GPP TS 23.502 V17.2.1 or a procedure of 5GS to EPS Idle mode mobility using N26 interface as described in clause 4.11.1.3.2 of 3GPP TS 23.502 V17.2.1.

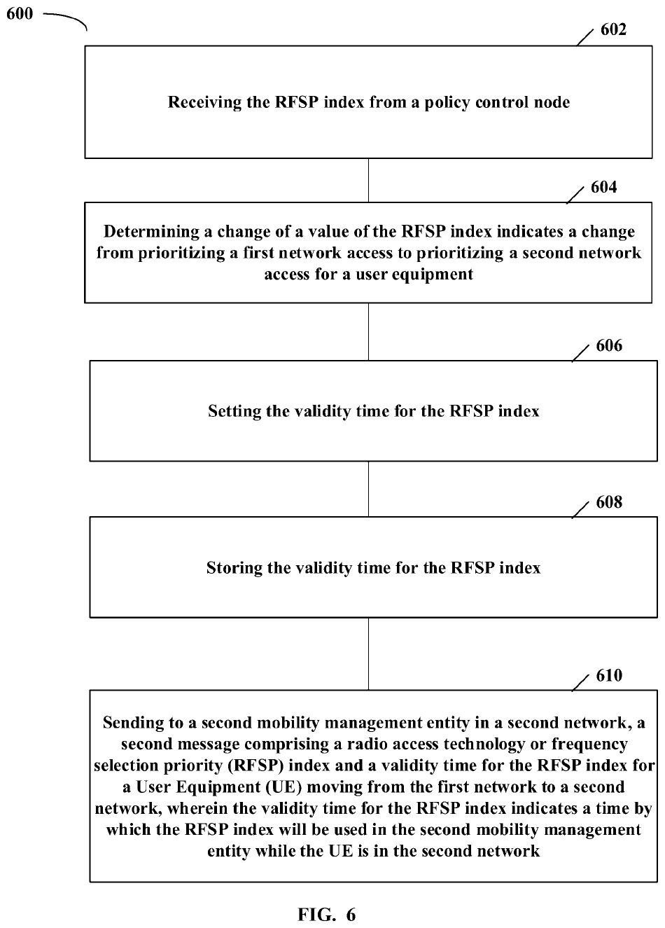

FIG. 8 shows a flowchart of a method according to another embodiment of the present disclosure, which may be performed by an apparatus implemented in/as or communicatively coupled to a second mobility management entity. As such, the apparatus may provide means for accomplishing various parts of the method 800 as well as means for accomplishing other processes in conjunction with other components. For some parts which have been described in the above embodiments, the description thereof is omitted here for brevity.

At block 802, the second mobility management entity may receive from a first mobility management entity in a first network, a second message comprising a radio access technology or frequency selection priority (RFSP) index and a validity time for the RFSP index for a User Equipment (UE) moving from the first network to the second network. The validity time for the RFSP index may indicate a time by which the RFSP index will be used in the second mobility management entity while the UE is in the second network.

In an embodiment, the second mobility management entity may be in a second network.

For example, the first mobility management entity may send the second message to the second mobility management entity at block 502 of FIG. 5, and then the second mobility management entity may receive the second message from the first mobility management entity.

At block 804, optionally, the second mobility management entity may store the RFSP index and the validity time for the RFSP index.

At block 806, the second mobility management entity may use the RFSP index for a period of time indicated by the validity time until the validity time expires.

In an embodiment, the second mobility management entity may ensure the RFSP index to take effect before the validity time for the RFSP index is due.

At block 808, optionally, the second mobility management entity may perform RFSP index re-evaluation when the validity time for the RFSP index expires. For example, the second mobility management entity may perform RFSP index re-evaluation as described in clause 4.3.6 of 3GPP TS 23.401 V17.3.

In an embodiment, the second message comprises at least one of a Forward Relocation Request, or a Context Response.

In an embodiment, the first mobility management entity is access and mobility function (AMF) and the second mobility management entity is Mobile Management Entity (MME).

In an embodiment, the second message is received from the first mobility management entity during at least one of a procedure of 5GS to EPS handover using N26 interface, or a procedure of 5GS to EPS Idle mode mobility using N26 interface.

In an embodiment, the first mobility management entity is MME and the second mobility management entity is MME.

In an embodiment, the second message is received from the first mobility management entity during at least one of a procedure of S1-based handover, or a procedure of S1-based Dual Active Protocol Stacks (DAPS) handover.

In an embodiment, the RFSP index indicates prioritizing 3GPP EPS access.

In an embodiment, the validity time for the RFSP index further indicates a time by which the RFSP index will take effect or be used in a specific network.

In an embodiment, the specific network comprises 3GPP EPS.

In an embodiment, when PCF provides authorized RFSP index to AMF.
If the PCF is aware of the mapping from RFSP index to cell selection and the RAT/Frequency Priorities, and the PCF determines that the change of authorized RFSP index value indicates a change from prioritizing 5G access to prioritizing 4G access for the UE, the PCF includes a validity time (e.g., a new information element (IE) “RFSPinUseExpiryTime”) indicating a time by which this RFSP index will take effect or be used if the UE moves to EPS.
If the PCF is not aware of the mapping from RFSP index to cell selection and the RAT/Frequency Priorities, the PCF does not include the validity time.

In an embodiment, when the AMF receives the authorized RFSP Index from the PCF,
If validity time is provided by the PCF, the AMF stores the validity time.
Otherwise, if validity time is not provided by PCF and if the AMF is aware of the mapping from RFSP index to cell selection and the RAT/Frequency Priorities and determines that the change of authorized RFSP index value indicates a change from prioritizing 5G access to prioritizing 4G access for the UE, the AMF sets and stores a validity time (e.g., “RFSPinUseExpiryTime”) indicating a time by which this RFSP index will take effect or be used if the UE moves to EPS.

In an embodiment, if the NG-RAN triggers handover before “RFSPinUseExpiryTime” is due, the AMF will include the new IE “RFSPinUseExpiryTime” in Forward Relocation Request to the MME. If the NG-RAN triggers release with redirect, the UE will perform Tracking Area Request procedure, and the AMF will include new IE “RFSPinUseExpiryTime” in Context Response before “RFSPinUseExpiryTime” is due.

In an embodiment, when the MME receives RFSPinUseExpiryTime, the MME will ensure that “RFSP index in use” takes effect. When the validity time indicated in RFSPinUseExpiryTime is due, the MME will do RFSP index re-evaluation.

In an embodiment, PCF sets validity time when authorizing an RFSP index.

In an embodiment, AMF sets validity time and provides it to MME.

In an embodiment, MME chooses RFSP index based on whether the validity time of the RFSP index is due.

In an embodiment, the proposed solution contains 3 parts: PCF to AMF, AMF to MME, and MME to MME.

### PCF to AMF

If the PCF is aware of the mapping from RFSP index to cell selection and the RAT/Frequency Priorities, and if the PCF determines that the change of authorized RFSP index value indicates a change from prioritizing 5G access to prioritizing 4G access for the UE, the PCF includes a validity time (working name “RFSPinUseExpiryTime”) indicating a time by which this RFSP index will take effect or be used if the UE moves to EPS.

### AMF to MME

In AMF:

If validity time is provided by the PCF, the AMF stores the validity time.

Otherwise if validity time is not provided by PCF, if the AMF is aware of the mapping from RFSP index to cell selection and the RAT/Frequency Priorities and determines that the change of authorized RFSP index value indicates a change from prioritizing 5G access to prioritizing 4G access for the UE, the AMF sets and stores a validity time (working name “RFSPinUseExpiryTime”) indicating a time by which this RFSP index will take effect or be used if the UE moves to EPS.

If the NG-RAN triggers handover before “RFSPinUseExpiryTime” is due. Clause 4.11.1.2.1 of 3GPP TS 23.502 V17.2.1 (5GS to EPS handover using N26 interface) is reused with the following addition:
In step 3 when AMF sends Forward Relocation Request to the MME, the AMF additionally includes a timestamp indicating to the MME that “RFSP index in use” should be used before the indicated time is due.

If the NG-RAN triggers release with redirect, the UE will perform Tracking Area Request procedure. Clause 4.11.1.3.2 of 3GPP TS 23.502 V17.2.1 (5GS to EPS Idle mode mobility using N26 interface) is reused with the following addition:
In step 6 when AMF sends Context Response to the MME, the AMF additionally includes a timestamp indicating to the MME that “RFSP index in use” should be used before indicated time is due.

In MME:

When the MME receives RFSPinUseExpiryTime, the MME will store it and ensure that “RFSP index in use” takes effect. When the validity time indicated in RFSPinUseExpiryTime is due, the MME will do RFSP index re-evaluation as specified in clause 4.3.6 of 3GPP TS 23.401 V17.3.0.

### (old/source) MME to (new/target) MME

If the UE moves further to another MME before the validity time (RFSPinUseExpiryTime) is due, the old MME includes the RFSPinUseExpiryTime in Forward Relocation Request or Context Response from the old MME to the new MME.

When the new/target MME receives validity time (RFSPinUseExpiryTime), the MME will store it and ensure that “RFSP index in use” takes effect. When the validity time indicated in RFSPinUseExpiryTime is due, the MME will do RFSP index re-evaluation as specified in clause 4.3.6 of 3GPP TS 23.401 V17.3.0.

In an embodiment, it proposes a solution for Key Issue #1 in 3GPP TR 23.700-89 V0.1.0 as follows:

The assumption is that AMF is aware of the mapping from RFSP index to cell selection and the RAT/Frequency Priorities which is typically known by RAN (see Annex I of 3GPP TS 36.300 V16.7.0 and Annex D in 3GPP TS 38.300 V16.8.0). Note that RFSP index is also known as “SPID” (Subscriber Profile ID) for RAT/Frequency Priority.

When the AMF receives the authorized RFSP Index from the PCF, if the AMF knows that the authorized RFSP index corresponds to a value that 4G should have priority, the AMF may store in the UE Context the time until this RFSP Index should apply (working name “RFSPinUseExpiryTime”).

If the NG-RAN triggers handover before “RFSPinUseExpiryTime”, the AMF will include such new parameter “RFSPinUseExpiryTime” in Forward Relocation Request to the MME.

If the NG-RAN triggers release with redirect, the UE will perform Tracking Area Request procedure, and the AMF will include new parameter “RFSPinUseExpiryTime” in Context Response if time is before “RFSPinUseExpiryTime”.

When the MME receives RFSPinUseExpiryTime, the MME will use “RFSP index in use”. When the RFSPinUseExpiryTime is due, the MME will do RFSP index re-evaluation as specified in clause 4.3.6 of 3GPP TS 23.401 V17.3.0 and the updated RFSP index will be sent to eNB which may direct the UE to the 5GS.

With the above, the UE is allowed to be directed back to 5GS after a configurable time, and the ping-pong issue can be alleviated without requiring keeping AMF-PCF association even if UE moves to EPS.

This proposal address only scenario with N26 deployment.

In an embodiment, it is proposed to include the following change in 3GPP TR 23.700-89 V0.1.0.

6.X Solution #X: AMF informing MME to use “RFSP in use” for a period of time

### 6.X.1 Description

The solution address KI #1 for deployment scenario with N26. In this solution,
The assumption is that AMF is aware of the mapping from RFSP index to cell selection and the RAT/Frequency Priorities which is typically known by RAN (see Annex I of 3GPP TS 36.300 V16.7.0 and Annex D in 3GPP TS 38.300 V16.8.0). Note that RFSP index is also known as “SPID” (Subscriber Profile ID) for RAT/Frequency Priority.
When the AMF receives the authorized RFSP Index from the PCF, if the AMF knows that the authorized RFSP index corresponds to a value that 4G should have priority, the AMF may store in the UE Context the time until this RFSP Index should apply (working name “RFSPinUseExpiryTime”).
If the NG-RAN triggers handover before “RFSPinUseExpiryTime”, the AMF will include the new parameter “RFSPinUseExpiryTime” in Forward Relocation Request to the MME. If the NG-RAN triggers release with redirect, the UE will perform Tracking Area Request procedure, and the AMF will include new parameter “RFSPinUseExpiryTime” in Context Response if time is before “RFSPinUseExpiryTime”.
When the MME receives RFSPinUseExpiryTime, the MME will use “RFSP index in use”. When the time indicated in RFSPinUseExpiryTime is due, the MME will do RFSP index re-evaluation as specified in clause 4.3.6 of 3GPP TS 23.401 V17.3.0.

NOTE: If the UE is not directed to EPS by NG-RAN before the time indicated in RFSPinUseExpiryTime is due, no action is needed in AMF.

### 6.X.2 Procedures

3GPP TS 23.502 V17.2.1, clause 4.11.1.2.1 (5GS to EPS handover using N26 interface) is reused with the following addition:
In step 3 when AMF sends Forward Relocation Request to the MME, the AMF additionally includes a timestamp indicating to the MME that “RFSP index in use” should be used before the indicated time is due. When the indicated time is due, the MME re-evaluates the RFSP index as specified in clause 4.3.6 of 3GPP TS 23.401 V17.3.0.

3GPP TS 23.502 V17.2.1, clause 4.11.1.3.2 (5GS to EPS Idle mode mobility using N26 interface) is reused with the following addition:
In step 6 when AMF sends Context Response to the MME, the AMF additionally includes a timestamp indicating to the MME that “RFSP index in use” should be used before indicated time is due. When the indicated time is due, the MME re-evaluates the RFSP index as specified in clause 4.3.6 of 3GPP TS 23.401 V17.3.0.

If the UE moves further from one MME to another MME before the time indicated in RFSPinUseExpiryTime is due, the old MME includes the RFSPinUseExpiryTime in Forward Relocation Request or Context Response from the old MME to the new MME.

### 6.X.3 Impacts

Impact on interface:

N26 and S10: Introduce additional IE (working name “RFSPinUseExpiryTime”) indicating the due time of “RFSP index in use”.

Impact on AMF:
When PCF provides authorized RFSP index, the AMF needs to be aware that the new value indicates that 4G has priority, and then decides to stores a timer (in the form of due time) in the UE Context and send it in the following GTP-C v2 messages informing the MME that “RFSP index in use” should be used before the indicated time is due:
Forward Relocation Request
Context Response

Impact on MME:
When receiving the new timer in Forward Relocation Request, or Context Response, the MME will store it in the UE Context and use “RFSP index in use” received from the AMF or an old MME. When the indicated time is due, the MME will re-evaluate the RFSP index as specified in clause 4.3.6 of 3GPP TS 23.401 V17.3.0.

Many advantages may be achieved by applying the proposed solution according to embodiments of the present disclosure. For example, in some embodiments herein, a benefit is that the UE is allowed to be directed back to a network such as 5GS after the configurable/validity time expires. In some embodiments herein, the ping-pong issue can be alleviated with minimal impact to the first network such as 5GS and the second network such as EPS. In some embodiments herein, the proposed solution can keep the impact to the first network such as 5GS and the second network such as EPS minimal. The embodiments herein are not limited to the features and advantages mentioned above. A person skilled in the art will recognize additional features and advantages upon reading the following detailed description.

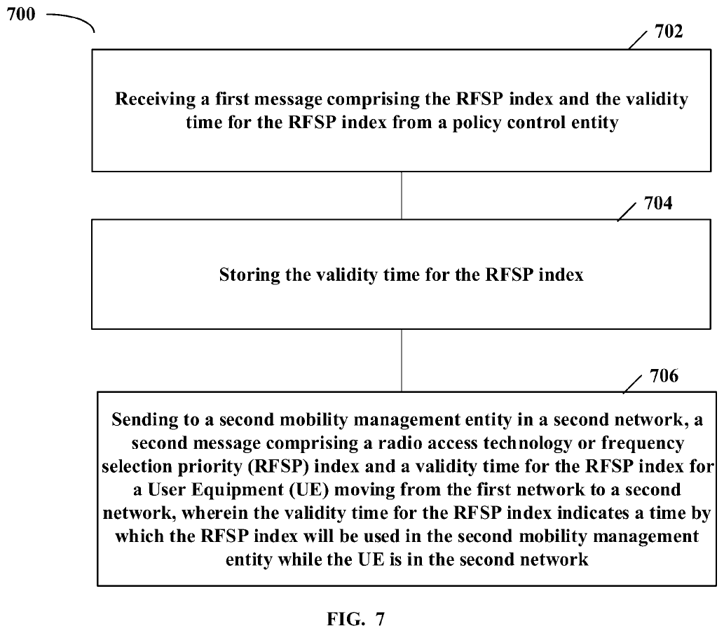

FIG. 9 is a block diagram showing an apparatus suitable for practicing some embodiments of the disclosure. For example, the policy control entity, the first mobility management entity, or the second mobility management entity described above may be implemented as or through the apparatus 900.

The apparatus 900 comprises at least one processor 921, such as a digital processor (DP), and at least one memory (MEM) 922 coupled to the processor 921. The apparatus 900 may further comprise a transmitter TX and receiver RX 923 coupled to the processor 921. The MEM 922 stores a program (PROG) 924. The PROG 924 may include instructions that, when executed on the associated processor 921, enable the apparatus 900 to operate in accordance with the embodiments of the present disclosure. A combination of the at least one processor 921 and the at least one MEM 922 may form processing means 925 adapted to implement various embodiments of the present disclosure.

Various embodiments of the present disclosure may be implemented by computer program executable by one or more of the processor 921, software, firmware, hardware or in a combination thereof.

The MEM 922 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 921 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the policy control entity, the memory 922 contains instructions executable by the processor 921, whereby the policy control entity operates according to any of the methods related to the policy control entity as described above.

In an embodiment where the apparatus is implemented as or at the first mobility management entity, the memory 922 contains instructions executable by the processor 921, whereby the first mobility management entity operates according to any of the methods related to the first mobility management entity as described above.

In an embodiment where the apparatus is implemented as or at the second mobility management entity, the memory 922 contains instructions executable by the processor 921, whereby the second mobility management entity operates according to any of the methods related to the second mobility management entity as described above.

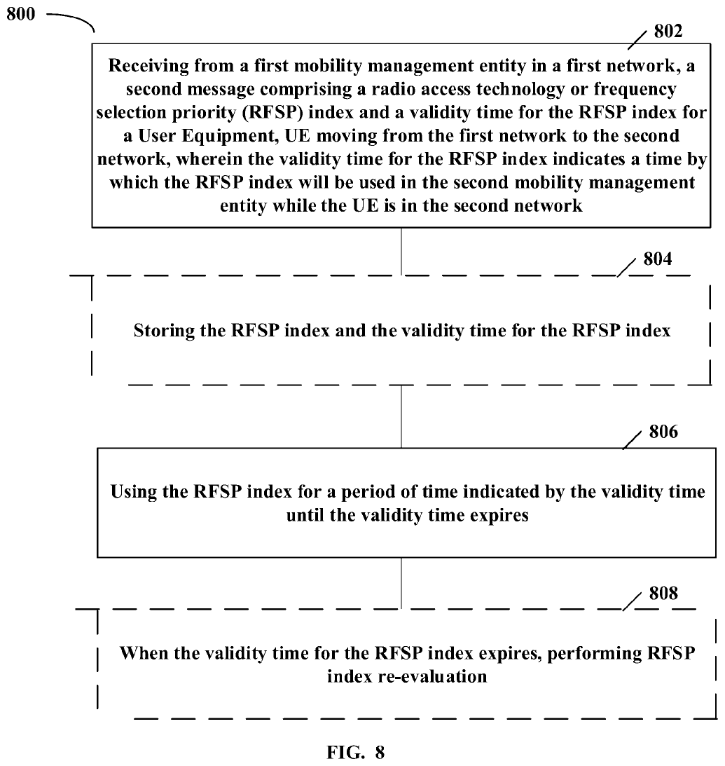

FIG. 10 is a block diagram showing a policy control entity in a first network according to an embodiment of the disclosure. As shown, the policy control entity 1000 comprises a setting module 1001 configured to set a validity time for a radio access technology or frequency selection priority (RFSP) index for a User Equipment (UE) moving from the first network to a second network. The validity time for the RFSP index may indicate a time by which the RFSP index will be used in the second mobility management entity while the UE is in the second network. The policy control entity 1000 further comprises a sending module 1002 configured to send a first message comprising the RFSP index and the validity time for the RFSP index to a mobility management entity in the first network.

In an embodiment, the policy control entity 1000 further comprises a determining module 1003 configured to determine a change of a value of the RFSP index indicates a change from prioritizing a first network access to prioritizing a second network access for a user equipment. In response to said determining, the validity time for the RFSP index is comprised in the first message.

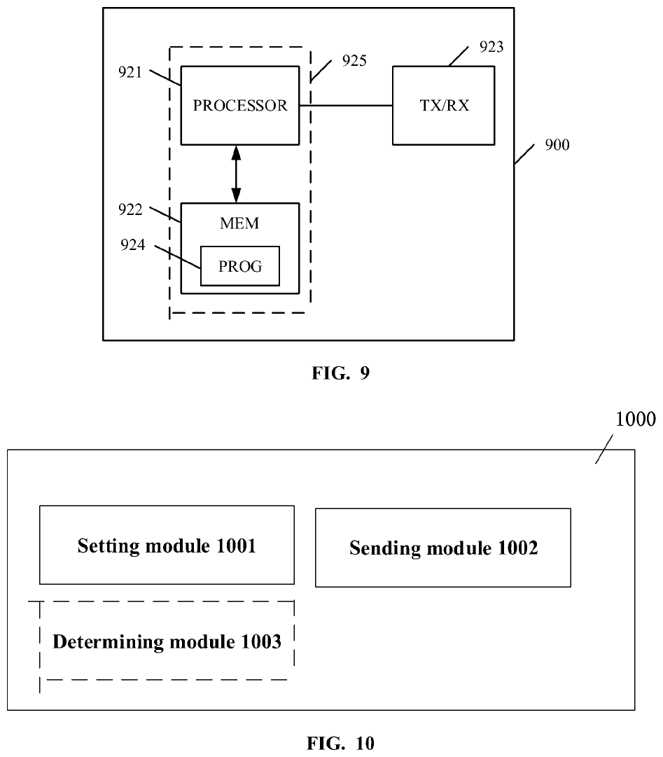

FIG. 11 is a block diagram showing a first mobility management entity in a first network according to an embodiment of the disclosure. As shown, the first mobility management entity 1100 comprises a sending module 1101 configured to send to a second mobility management entity in a second network, a second message comprising a radio access technology or frequency selection priority (RFSP) index and a validity time for the RFSP index for a User Equipment (UE) moving from the first network to a second network. The validity time for the RFSP index may indicate a time by which the RFSP index will be used in the second mobility management entity while the UE is in the second network.

In an embodiment, the first mobility management entity 1100 further comprises a first receiving module 1102 configured to receive the RFSP index from a policy control entity.

In an embodiment, the first mobility management entity 1100 further comprises a determining module 1103 configured to determine a change of a value of the RFSP index indicates a change from prioritizing a first network access to prioritizing a second network access for a user equipment.

In an embodiment, the first mobility management entity 1100 further comprises a setting module 1104 configured to set the validity time for the RFSP index.

In an embodiment, the first mobility management entity 1100 further comprises a first storing module 1105 configured to store the validity time for the RFSP index.

In an embodiment, the first mobility management entity 1100 further comprises a second receiving module 1106 configured to receive a first message comprising the RFSP index and the validity time for the RFSP index from a policy control entity.

In an embodiment, the first mobility management entity 1100 further comprises a second storing module 1107 configured to store the validity time for the RFSP index.

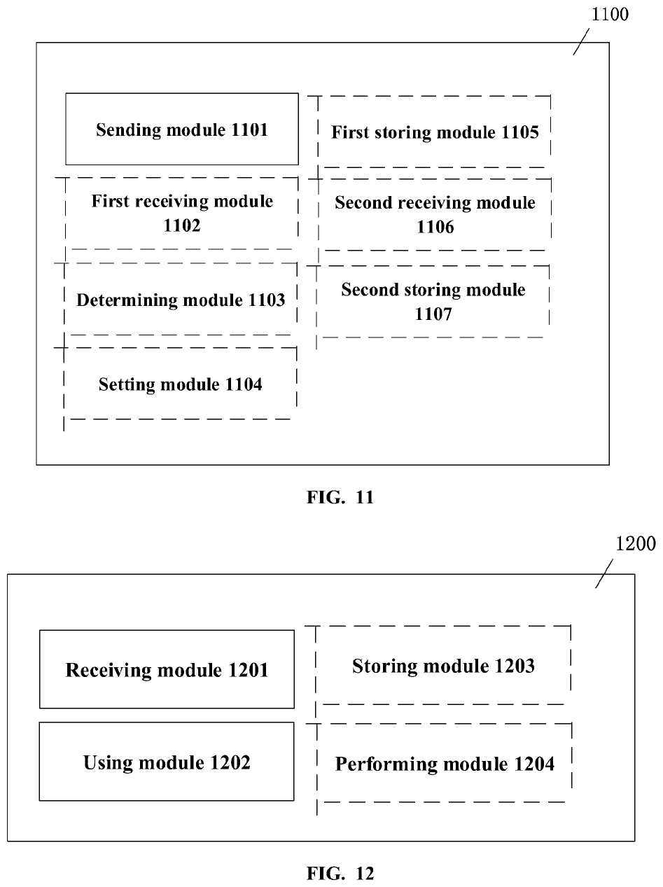

FIG. 12 is a block diagram showing a second mobility management entity in a second network according to an embodiment of the disclosure. As shown, the second mobility management entity 1200 comprises a receiving module 1201 configured to receive from a first mobility management entity in a first network, a second message comprising a radio access technology or frequency selection priority (RFSP) index and a validity time for the RFSP index for a User Equipment (UE) moving from the first network to the second network. The validity time for the RFSP index may indicate a time by which the RFSP index will be used in the second mobility management entity while the UE is in the second network. The second mobility management entity 1200 further comprises a using module 1202 configured to use the RFSP index for a period of time indicated by the validity time until the validity time expires.

In an embodiment, the second mobility management entity 1200 further comprises a storing module 1203 configured to store the RFSP index and the validity time for the RFSP index.

In an embodiment, the second mobility management entity 1200 further comprises a performing module 1204 configured to perform RFSP index re-evaluation when the validity time for the RFSP index expires.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the policy control entity, the first mobility management entity, or the second mobility management entity may not need a fixed processor or memory, any computing resource and storage resource may be arranged from the policy control entity, the first mobility management entity, or the second mobility management entity in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a policy control entity in a first network, comprising:
setting a validity time for a radio access technology or frequency selection priority (RFSP) index for a User Equipment (UE) moving from the first network to a second network; and
sending a first message comprising the RFSP index and the validity time for the RFSP index to a mobility management entity in the first network,
wherein the validity time for the RFSP index indicates a time by which the RFSP index will be used in the second mobility management entity while the UE is in the second network.

2. The method according to claim 1, further comprising:
determining a change of a value of the RFSP index indicates a change from prioritizing a first network access to prioritizing a second network access for a user equipment,
wherein in response to said determining, the validity time for the RFSP index is comprised in the first message.

3. The method according to claim 2, wherein the first network comprises 3rd Generation Partnership Project (3GPP) fifth generation system (5GS) and the second network comprises 3GPP Evolved Packet System (EPS).

4. The method according to claim 1, wherein the first message comprises at least one of:
an access and mobility management entity policy control create response, or
an access and mobility management entity policy control update notify.

5. The method according to claim 1, wherein the policy control entity comprises Policy Control Function (PCF); wherein the mobility management entity comprises access and mobility function (AMF); wherein the second mobility management entity is Mobile Management Entity (MME).

6. The method according to claim 1, wherein the RFSP index indicates prioritizing 3GPP EPS access.

7. A method performed by a first mobility management entity in a first network, comprising:
sending to a second mobility management entity in a second network, a second message comprising a radio access technology or frequency selection priority (RFSP) index and a validity time for the RFSP index for a User Equipment (UE) moving from the first network to a second network,
wherein the validity time for the RFSP index indicates a time by which the RFSP index will be used in the second mobility management entity while the UE is in the second network.

8. The method according to claim 7, wherein the first network comprises 3rd Generation Partnership Project (3GPP) fifth generation system (5GS) and the second network comprises 3GPP Evolved Packet System (EPS).

9. The method according to claim 7, further comprising:
receiving a first message comprising the RFSP index and the validity time for the RFSP index from a policy control entity; and
storing the validity time for the RFSP index.

10. The method according to claim 9, wherein the first message comprises at least one of:
an access and mobility management entity policy control create response, or
an access and mobility management entity policy control update notify.

11. (canceled)

12. The method according to claim 7, wherein the policy control entity Policy Control Function (PCF), the first mobility management entity is access and mobility function (AMF) and the second mobility management entity is Mobile Management Entity (MME).

13. The method according to claim 7, wherein the second message is sent to the second mobility management entity during at least one of:
a procedure of 5GS to EPS handover using N26 interface, or
a procedure of 5GS to EPS Idle mode mobility using N26 interface.

14. The method according to claim 7, wherein the second message comprises at least one of:
a Forward Relocation Request, or
a Context Response.

15. (canceled)

16. A method performed by a second mobility management entity in a second network, comprising:
receiving from a first mobility management entity in a first network, a second message comprising a radio access technology or frequency selection priority (RFSP) index and a validity time for the RFSP index for a User Equipment (UE) moving from the first network to the second network, wherein the validity time for the RFSP index indicates a time by which the RFSP index will be used in the second mobility management entity while the UE is in the second network; and
using the RFSP index for a period of time indicated by the validity time until the validity time expires.

17. The method according to claim 16, further comprising:
when the validity time for the RFSP index expires, performing RFSP index re-evaluation.

18. The method according to claim 16, further comprising:
storing the RFSP index and the validity time for the RFSP index.

19. The method according to claim 16, wherein the second message comprises at least one of:
a Forward Relocation Request, or
a Context Response.

20. The method according to claim 16, wherein the first mobility management entity is access and mobility function (AMF) and the second mobility management entity is Mobile Management Entity (MME).

21. The method according to claim 16, wherein the second message is received from the first mobility management entity during at least one of:
a procedure of 5GS to EPS handover using N26 interface, or
a procedure of 5GS to EPS Idle mode mobility using N26 interface.

22. The method according to claim 16, wherein the RFSP index indicates prioritizing 3GPP EPS access.

23. A policy control entity, comprising:
a processor; and
a memory coupled to the processor, said memory containing instructions executable by said processor, whereby said policy control entity is operative to:
set a validity time for a radio access technology or frequency selection priority (RFSP) index for a User Equipment (UE) moving from a first network to a second network; and
send a first message comprising the RFSP index and the validity time for the RFSP index to a mobility management entity in the first network,
wherein the validity time for the RFSP index indicates a time by which the RFSP index will be used in the second mobility management entity while the UE is in the second network.

24. The policy control entity according to claim 23, wherein:
the first network comprises 3rd Generation Partnership Project (3GPP) fifth generation system (5GS) and the second network comprises 3GPP Evolved Packet System (EPS);
wherein the first message comprises at least one of an access and mobility management entity policy control create response, or an access and mobility management entity policy control update notify; and
the policy control entity comprises Policy Control Function (PCF), the mobility management entity comprises access and mobility function (AMF), and the second mobility management entity is Mobile Management Entity (MME).

25. A first mobility management entity, comprising:
a processor; and
a memory coupled to the processor, said memory containing instructions executable by said processor, whereby said first mobility management entity is operative to:
send to a second mobility management entity in a second network, a second message comprising a radio access technology or frequency selection priority (RFSP) index and a validity time for the RFSP index for a User Equipment (UE) moving from the first network to a second network,
wherein the validity time for the RFSP index indicates a time by which the RFSP index will be used in the second mobility management entity while the UE is in the second network.

26. The first mobility management entity according to claim 25, wherein the first mobility management entity is further operative to:
receive a first message comprising the RFSP index and the validity time for the RFSP index from a policy control entity, and store the validity time for the RFSP index;
wherein the first message comprises at least one of an access and mobility management entity policy control create response, or an access and mobility management entity policy control update notify.

27. A second mobility management entity, comprising:
a processor; and
a memory coupled to the processor, said memory containing instructions executable by said processor, whereby said second mobility management entity is operative to:
receive from a first mobility management entity in a first network, a second message comprising a radio access technology or frequency selection priority (RFSP) index and a validity time for the RFSP index for a User Equipment (UE) moving from the first network to the second network, wherein the validity time for the RFSP index indicates a time by which the RFSP index will be used in the second mobility management entity while the UE is in the second network; and
use the RFSP index for a period of time indicated by the validity time until the validity time expires.

28. The second mobility management entity according to claim 27, wherein the second mobility management entity is further operative to:
store the RFSP index and the validity time for the RFSP index;
wherein the second message comprises at least one of a Forward Relocation Request, or a Context Response.

29. (canceled)

30. (canceled)
